(19) United States
(12) Patent Application Publication
(10) Pub. No.: US 2024/0273569 A1
(43) Pub. Date: Aug. 15, 2024

(54) METHOD AND SYSTEM FOR DIGITAL ADVERTISEMENT OPTIMIZATION

(71) Applicant: AIQUIRE INC., Chicago, IL (US)

(72) Inventors: Vrushali PRASADE, Thane, (West) (IN); Kirill Borisovich DUBOVIKOV, Moscow (RU); Vivek KUMAR, Ara (IN); Mrunal NASERY, Bangalore (IN); Satyam VIVEK, Bengaluru (IN); Shubham MISHRA, Bengaluru (IN); Vivek Vishwas VICHARE, Bangalore (IN); Sujith BENHUR, Bengaluru (IN); Piyush JAISWAL, Bengaluru (IN)

(73) Assignee: AIQUIRE INC., Chicago, IL (US)

(21) Appl. No.: 18/289,421

(22) PCT Filed: Dec. 13, 2022
(86) PCT No.: PCT/US2022/052757

§ 371 Date: Nov. 3, 2023

(30) Foreign Application Priority Data
Dec. 13, 2021 (IN) 202141057866
Dec. 13, 2022 (IN) 202214071990

(51) Int. Cl. G06Q 30/0242

(52) U.S. Cl. CPC G06Q 30/0242

(57) ABSTRACT

A digital advertisement optimization system for digital advertisement optimization is described. The system includes a budget pacing module for selecting a budget pacing model from a group of budget pacing models, and a budget distributor module for selecting a budget distributor model from a group of budget distributor models. The system further includes a single platform budget optimization module for allocating a budget, within each advertisement platform of a group of advertisement platforms for the digital advertisement optimization, to advertisement sets based at least in part on the selected budget pacing model, the selected budget distributor model, and one or more single platform budget optimization models.

### RELATED APPLICATION(S)

This application claims priority from the Indian Provisional Patent Application Number 202141057866, filed on Dec. 13, 2021, and titled “A System And Method For Optimizing Bids and Budget Of An AD Campaign,” which is hereby incorporated by reference in its entirety.

### FIELD OF THE INVENTION

The embodiments herein generally relate to digital advertisement optimization. In particular, the embodiments presented relate to a method and system for digital advertisement optimization for online advertisement sets (ad sets).

### BACKGROUND OF THE INVENTION

Digital platforms are spaces where advertisers intend to place their ads to attract potential customers and thereby generate revenue. For this purpose, advertisers set aside a budget they want to spend on digital advertising for a certain period of time. Conventionally, it is a tedious and challenging task to decide the optimal way of pacing budget (allocating budget to be spent on different days across all advertisement platforms) and budget allocation (first optimally allocating budget across different advertisement platforms, and then, allocating budget among different ad sets within each advertisement platform). As such, advertisers end up allocating the same budget manually every day on digital advertisements. Further, many advertisers often find it inconvenient to compare the performance of their ad sets across different advertisement platforms on a more frequent basis since data for each advertisement platform is available only within the same advertisement platform. The advertisers often need to spend extra effort to aggregate data from each advertisement platform, compare their associated performances, and redistribute budget across different advertisement platforms for different ad sets.

Further, conventional solutions for digital advertisement optimization do not provide recommendation(s) on action(s) that should be taken by the advertiser(s) in response to detecting performance stagnation in ad set(s) of a particular advertisement platform. For instance, when an ad set is live online, advertisers generally shift their focus elsewhere. Due to various factors, the performance of any ad set can degrade at any point in time (e.g., in a day). In such cases, those ad sets need to be paused until an underlying cause of performance degradation is identified. Otherwise, it can lead to high daily spend with low returns. Additionally, advertisers find it difficult to monitor the performance of their ad sets constantly and manually throughout the day, and manually vary the already allocated bids and/or budgets based on the performance of the ad sets. Further, at several instances, it is not inherently obvious for the advertisers to identify the above-mentioned underlying causes for performance degradation, which may eventually be challenging.

Furthermore, conventions solutions in the digital advertisement optimization domain do not provide tool(s) that enables advertisers to test different models related to fixing budget for ad set(s) in the historical time period, and select one or more models (from amongst the tested models) that may aid in increased revenue generation for the advertisers. In particular, advertisers do not have an optimal way to determine the possible effects of changing bid and/or budget by a certain percentage on performance of the ad sets. Consequently, it leaves the advertisers with no choice but to actually execute a model (or strategy) live to fix budget for an ad set and/or to determine the effectiveness of the model. Using models (or strategies) for the first time (to fix budget) on the ad sets brings in a certain level of uncertainty, which may further affect the performance of the model.

Further, no current solution in the digital advertisement optimization domain provides custom-made strategies as templates which can be applied on different ad sets across one or more advertisement platforms. The conventional templates recommend different actions (to be taken on the ad sets) based on different performance criteria associated with the ad sets. Conventional solutions also do not provide the flexibility to set the recommended actions for each performance criteria.

Further, the conventional solutions do not provide the ability to integrate models (related to fixing budget for ad set(s) for advertisement platform(s)) into the existing digital advertisement optimization system(s).

Therefore, there is a need to overcome the above-described challenges for digital advertisement optimization of ad sets.

### OBJECTS OF THE INVENTION

An objective of the embodiments presented herein is to provide an Artificial Intelligence (AI) enabled digital advertisement optimization system and a corresponding method to provide cross-platform budget pacing and budget allocation optimization for digital media advertising, along with AI-based simulations and action type recommendations for ad sets to provide effective digital advertisement optimization. A further objective of the embodiments presented herein is to provide an end-to-end AI-based ads management system and a corresponding method that may assist advertisers in automating and optimizing their ad sets across different advertisement platforms.

Further, another objective of the embodiments presented herein is to provide digital advertisement optimization systems that are built with a plug-and-play approach, wherein new models (that may be used to fix budget for ad sets) may be easily integrated into the overall AI solution for digital advertisement optimization.

A further objective of the embodiments of the present disclosure is to provide an AI simulation system that enables advertisers to test performance of one or more models (used to fix budget for ad sets across different advertisement platforms) on historical data associated with different advertisement platforms. This enables the advertisers to understand how the one or more models would have performed on the ad sets of the advertisers, if deployed. Based on results of the tests, the embodiments of the present disclosure enable the advertisers to select a model (for fixing budget of their ad sets) best suited for their needs and also tune the parameters of the selected model.

The above objectives bring together both automation and optimization for online advertisers resulting in reduction in effort and simultaneously, improving the performance of ad sets across different advertisement platforms.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY OF THE INVENTION

Embodiments of a digital advertisement optimization system and a corresponding method are disclosed that address at least some of the above challenges and issues.

In accordance with the embodiments of this disclosure, an AI-enabled digital advertisement optimization system is described. The system includes a budget pacing module that selects a budget pacing model from a group of budget pacing models. The system further includes a budget distributor module that selects a budget distributor model from a group of budget distributor models. Furthermore, the system includes a single platform budget optimization module that allocates a budget, within each advertisement platform of a group of advertisement platforms for the digital advertisement optimization, to ad sets based at least in part on the selected budget pacing model, the selected budget distributor model, and one or more single platform budget optimization models.

Further, in accordance with the embodiments of this disclosure, a method implemented by a system for digital advertisement optimization is disclosed. The method includes selecting a budget pacing model from a group of budget pacing models: selecting a budget distributor model from a group of budget distributor models; and allocating a budget, within each advertisement platform of a group of advertisement platforms for the digital advertisement optimization, to advertisement sets based at least in part on the selected budget pacing model, the selected budget distributor model, and one or more single platform budget optimization models.

### BRIEF DESCRIPTION OF THE DRAWINGS

Further advantages of the invention will become apparent by reference to the detailed description of preferred embodiments when considered in conjunction with the drawings:

FIG. 1 illustrates a user interface and the various modules of an automated end-to-end digital advertisement optimization system, according to some embodiments.

FIG. 2 illustrates an exemplary flowchart depicting the various steps involved in digital advertisement optimization, according to some embodiments.

FIG. 3 illustrates the various components of a budget pacing module, according to some embodiments.

FIG. 4 illustrates an exemplary process performed by a single platform budget optimization module for providing bid and budget recommendations, according to some embodiments.

FIG. 5 illustrates an exemplary process performed by an action type recommender module for suggesting action types for advertisement platforms, according to some embodiments.

FIG. 6 illustrates an exemplary process performed by an AI simulator module for presenting optimization potential of each model configuration, according to some embodiments.

FIG. 7 illustrates an exemplary flowchart depicting the various steps performed by an AI simulator module for facilitating selection of one or more models (that may be used to fix budget for ad sets across different advertisement platforms), according to some embodiments.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure.

“Budget pacing” may refer to the process of tracking and optimizing elements of digital ad sets in order to control the rate at which the ad sets spend. The purpose of budget pacing may be to achieve a target budget and/or performance goals by the end of the budgeting cycle.

“Advertisement Platforms” may be designed with the aim of bringing together advertisers, publishers, agencies, and other buyers in one place. This may allow for purchasing advertising inventory at reasonable rates. Some advertisement platforms may also offer technology that helps manage ad sets on behalf of their clients while some others may act as a complete solutions provider for agencies who do not have the time or resources to manage their own digital ad sets. In some examples, the “Advertising Platforms” may include, but are not limited to, Google Ads, Bing Ads, Facebook Ads, Instagram Ads, Twitter Ads, LinkedIn Ads and similar marketing platforms.

“Advertisement sets (ad sets)” may refer to groups of advertisements that share settings for how, when and where to run said ad sets. When an ad set is created, the choices (with respect to the characteristics of the ad sets) made at the ad set level may automatically apply to all of the ads in the ad sets.

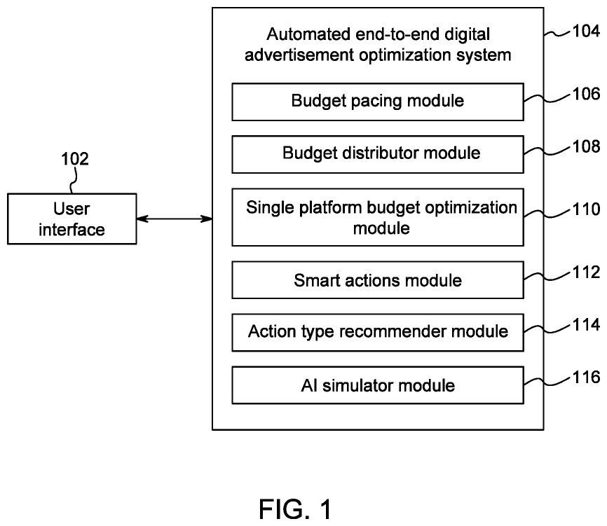

These and other embodiments of the methods and systems are described in more detail with reference to FIGS. 1-7.

FIG. 1 illustrates a user interface 102 and the various modules of an automated end-to-end digital advertisement optimization system 104, according to some embodiments. In some embodiments, the digital advertisement optimization system 104 may be located at a server end. In some embodiments, the digital advertisement optimization system 104 may be implemented in one or more of a data aggregation module: a data processing module: user inputs, model selection, and configuration interface module, and a model training and inference module. Further, the digital advertisement optimization system 104 may be implemented virtually and/or physically depending at least in part on design requirements. In some embodiments, the digital advertisement optimization system 104 may be realizable through cloud computing. In the embodiment illustrated in FIG. 1, the digital advertisement optimization system 104 may include a budget pacing module 106, a budget distributor module 108, a single platform budget optimization module 110, a smart actions module 112, an action type recommender module 114, and an AI simulator module 116.

In some embodiments, the budget pacing module 106 may be operable to implement budget pacing considering the total budget for the ad sets across different advertisement platforms for a specific time duration. This time duration, for instance, may be set up by the advertiser through the user interface 102. The budget pacing module 106 may be operable to decide the total daily budget for each day (for the ad sets across different advertisement platforms) in the given time duration.

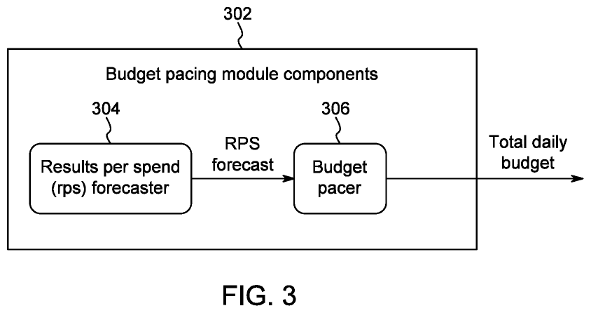

To implement budget pacing, the budget pacing module 106 may be configured to store a suite of multiple budget pacing models. These models may, for instance, be stored by a service provider while setting up the digital advertisement optimization system 104. In some embodiments, a user (e.g., an advertiser) may also provide additional budget pacing models to the budget pacing module 106, which may further integrate them into the digital advertisement optimization system 104 for a later use in determining appropriate strategies for digital advertising. In some embodiments, the multiple budget pacing models may include an adaptive sarimax pacer model which is illustrated in more detail, in the description of FIG. 3 later in this disclosure.

In some embodiments, the budget pacing module 106 may be operable to determine a total daily budget to be spent on ad sets across all advertisement platforms for a time duration based at least in part on a budget pacing model selected from a plurality of budget pacing models. In some embodiments, the total daily budget may be determined using historical data associated with ad sets of all advertisement platforms. This is described in more detail, in the description of FIG. 3 later in this disclosure. Further, the digital advertising optimization system 104 may allow for addition of new budget pacing models to the existing budget pacing models by advertisers or by any other entity.

Further, once the total daily budget is made available by the budget pacing module 106 to the budget distributor module 108, the budget distributor module 108 may be operable to distribute (or redistribute in case a total daily budget was previously distributed amongst different advertisement platforms) the total daily budget across different advertisement platforms using a budget distributor model. An example of a budget distributor model may be a linear programming based distributor model. The linear programming based distributor model may facilitate standardization of performance of ad sets across different advertisement platforms. To facilitate the standardization of performance of ad sets across different advertisement platforms, the budget distributor module 108 (by using the linear programming based distributor model) may compare performance of ad sets across different advertisement platforms by aggregating data (related to ad sets) from different advertisement platforms. Post that, an N-day weighted average of results per spend (wRPS) for each advertisement platform is determined. The wRPS of each advertisement platform is then fed to the linear programming based distributor model that analyses the wRPS of all the advertisement platforms, and then the budget distributor module 108 optimally redistributes the total daily budget amongst different advertisement platforms based on the analysis. In some embodiments, the performance of ad sets is measured through various metrics including, but not limited to, wRPS, results, Cost per Results (CPR) etc.

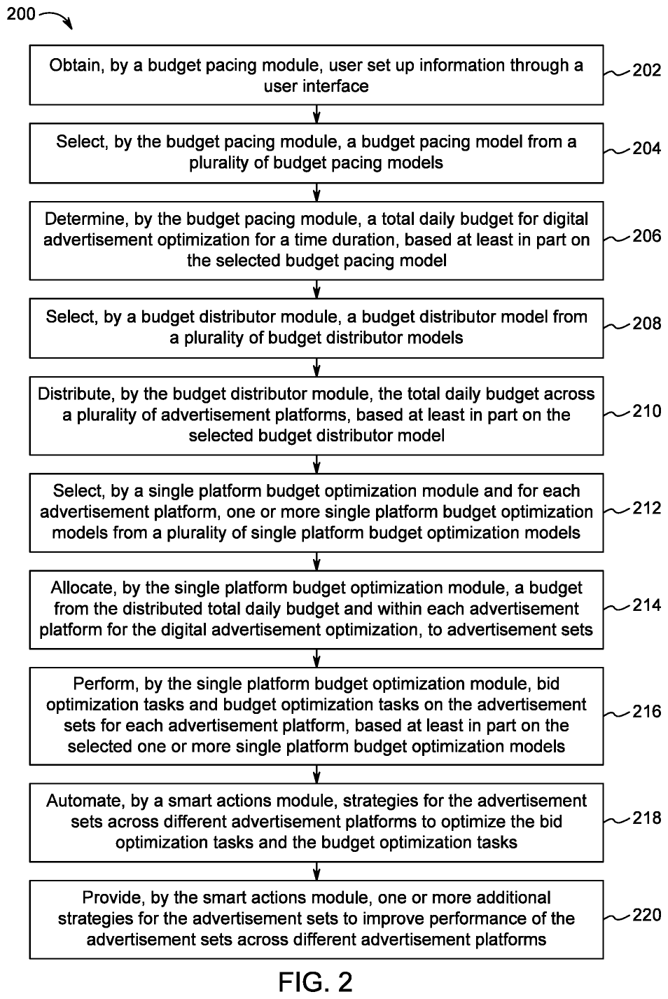

Thus, in some embodiments, the budget distributor module 108 may facilitate distribution (or redistribution) of the total daily budget across different advertisement platforms based at least in part on the budget distributor model (selected from a plurality of budget distributor models). Further, the aspects related to budget distributor module 108 are described in more detail in the context of FIG. 2 described later. Furthermore, the digital advertisement optimization system 104 may facilitate integration of new budget distributor models to existing budget distributor models (of the digital advertisement optimization system 104) by advertisers or by any other entity.

Further, in some embodiments, the single platform budget optimization module 110 may be operable to optimally allocate budget within each advertisement platform and optimize a bid value of relevant entities such as ad sets across different advertisement platforms.

The single platform budget optimization module 110 may provide advertisers with a plurality of bid and budget optimization models which contain multiple types of models that have already been developed and deployed by various advertisers. Additionally, the plurality of the bid and budget optimization models is quite flexible in the sense that a new bid and budget optimization model can be easily integrated by the advertisers or any other entity to the existing models stored in a memory of digital advertisement optimization system 104.

A few examples of actions performed by one or more of the single platform budget optimization modules 110 are provided below. These examples are non-limiting and do not restrict the presented embodiments in any manner. In an example, in a first advertising scenario, there is an ad set which has a low cost per result (CPR) but it is unable to deliver a desired scale i.e., number of results achieved by it are less as compared to other ad sets that have poor (i.e., high) CPR performance. For this ad set, the single platform budget optimization module 110 may recommend an increase in its budget since it has a good CPR performance and can give higher number of results (scale) as compared to other ad sets with similar budget (but with low CPR). In such advertising scenarios, the single platform budget optimization module 110 may recommend an action such as ‘increase budget’ with a fixed value (for example an increase of 5% or 10% over the previously allocated budget). In another example, in another advertising scenario, there is an ad set that has a poor (i.e., high) CPR performance and it is unable to deliver a desired scale i.e., the number of results achieved by it is less as compared to other ad sets. In this case, the ideal action will be to decrease the budget from this ad set as it does not deliver the desired returns. Accordingly, the single platform budget optimization module 110 may recommend an action such as ‘decrease budget’ from this ad set with some fixed value (for example a decrease by 5% or 10% over the previously allocated budget).

In some embodiments, the single platform budget optimization module 110 may implement one or more of a plurality of single platform budget optimization models for allocating budget and optimizing bid values for ad sets across different advertisement platforms. Further, the aspects related to single platform budget optimization module 110 are described in more detail in the context of FIG. 2 described later.

In some embodiments, the smart actions module 112 may be operable to provide and automate strategies for ad sets across different advertisement platforms to optimize bid and budget optimization tasks performed by the single platform budget optimization module 110. Further, the smart actions module 112 is operable to provide one or more additional strategies for the ad sets to improve performance of the ad sets across different advertisement platforms. In some embodiments, the one or more additional strategies may be preconfigured by the advertiser or by any other entity.

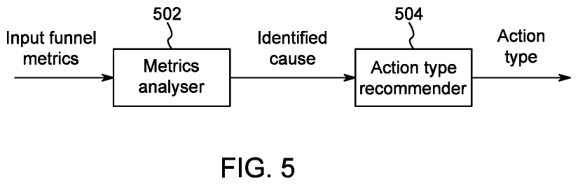

Further, an action type recommender module 114 is operable to constantly monitor the performance of ad sets across different advertisement platforms throughout a time duration (in an example, during a day), and adjust the characteristics associated with the ad sets accordingly based on the performance of ad sets. When it comes to performance improvement of ad sets across different advertisement platforms, budget and bid (associated with the ad sets) are not the only factors that play an important role. At several instances, there can be different causes such as creative exhaustion (lack of creativity) of ad sets, audience saturation, etc. In such scenarios, the action type recommender module 114 may analyze the entire funnel metrics (from total audience reach to final conversion/result metric) of the ad sets to understand the underlying cause, and then recommend suitable actions. The various components of action type recommender module 114 are illustrated and described in more detail in the context of FIG. 5, later in this disclosure.

In some embodiments, the AI simulator module 116 is operable to test one or more of the budget pacing models, budget distributor models, and single platform budget optimization models, on a historical set of data related to ad sets of advertisement platforms. Further, the AI simulator module 116 is operable to facilitate one or more modules (106, 108, 110) to select one or more of a budget pacing model, a budget distributor model, and one or more single platform budget optimization models based at least in part on results of the testing. Thus, in some embodiments, the above operations performed by the AI simulator module 116 result in an efficient allocation of budget, within each advertisement platform for the digital advertisement optimization, to ad sets.

FIG. 2 illustrates an exemplary flowchart 200 depicting the various steps involved in digital advertisement optimization, according to some embodiments. In some embodiments, the steps of the flowchart 200 may be implemented by the digital advertisement optimization system 104 of FIG. 1.

In some embodiments, in step 202, the budget pacing module 106 may obtain user set up information through the user interface 102. In some embodiments, the user set up information may include the time duration during which the ad sets may be live on various advertisement platforms, the one or more user-specified parameters for models (associated with fixing a budget for ad sets for digital advertising), and the user-specified budget (total budget) to be spent on ad sets across all advertisement platforms. In some embodiments, the user set up information may be obtained in response to setting up the time duration (during which ad sets are live across advertisement platforms) for digital advertising, setting up one or more user-specified parameters for various models (associated with fixing budget for ad sets for digital advertising), and setting up the user-specified budget (total budget) required for ad sets across all advertisement platforms.

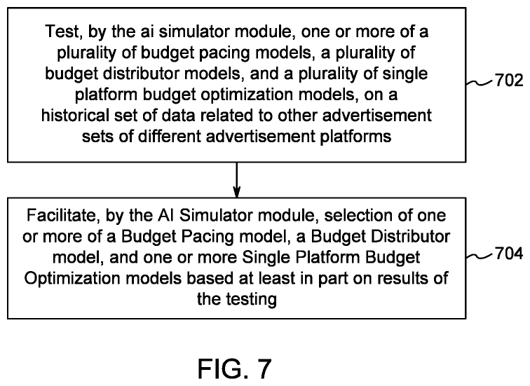

Further, in step 204 illustrated in FIG. 2, the budget pacing module 106 may select a budget pacing model from a plurality of budget pacing models (that may be stored in the digital advertisement optimization system 104). The process of budget pacing, as described in this disclosure, may include determining an optimal budget for each day to be spent on ad sets across various advertisement platforms. Further, the process of selecting the budget pacing model may be based at least in part on information provided by the advertiser or any other entity (in step 202 along with the user set up information or before step 202). Alternatively or additionally, the process of selecting the budget pacing model may be based at least in part on steps 702 and 704 described in FIG. 7, which is described in more detail later in this disclosure.

Additionally, the budget pacing module 106 may be configured to integrate one or more user-defined budget pacing models to the plurality of budget pacing models, which are stored in a memory of the digital advertisement optimization system 104. These additional user-defined budget pacing models may be integrated into the existing stored plurality of budget pacing models via a plug-and-play mechanism. In some embodiments, the plug-and-play mechanism may include integrating new models of any type such as budget pacing, budget distributor, and single platform budget optimization models with the stored models (stored at the digital advertisement optimization system 104). Further, the plug-and-play mechanism may include instantaneously using the integrated new models on live ad sets to perform optimization and monitoring the performance of the ad sets, after integration of the new models. Further, through the plug-and-play mechanism, one or more models (discussed throughout the disclosure) may be easily deployed by pushing code (associated with the one or more models that are to be deployed) into a cloud-based server. After deployment, the model may be available for use in the user interface 102 and/or at the digital advertisement optimization system 104. The new models (to be deployed) may be developed by advertisers and/or any other entity.

In some embodiments, the plurality of budget pacing models may include at least an adaptive sarimax pacer model and a marginal returns pacer model.

In some embodiments, the models (discussed throughout the disclosure) may be stored in the memory of the digital advertisement optimization system 104 by the advertiser or any other entity beforehand, when the digital advertisement optimization system 104 is configured for live online deployment. The embodiments presented herein also enable an advertiser or any other entity to deploy any model (discussed throughout the disclosure) using a plug-and-play mechanism.

Further, in step 206, the budget pacing module 106 may determine a total daily budget for various ad sets across different advertisement platforms based at least in part on the budget pacing model selected in step 204. In an exemplary scenario, the budget pacing module 106 may determine the total daily budget by forecasting a number of results per day for a unit cost spent on one or more advertisements across the plurality of advertisement platforms. In some embodiments, the number of results per day includes a number of clicks and a number of conversions associated with the one or more advertisements. Additionally, the budget pacing module 106 may compare the forecasted number of results per day with historical data associated with the one or more advertisements based at least in part on the selected budget pacing model, and then, determine the total daily budget based at least in part on results of this comparison. In some embodiments, the total daily budget may be made to vary in time. In some embodiments, the historical data may include a results per day (including a number of clicks and a number of conversions associated with the one or more advertisements) obtained in the last N days.

Currently there are no solutions available (in the commercial market) that help advertisers optimally pace their budget across a time duration. In most of the cases, advertisers end up allocating the same budget manually every day for the ad sets across different advertisement platforms.

Conventionally, some ad sets show weekly seasonality behavior i.e., they give better performance on some specific days of the week. Therefore, pacing advertising budgets accordingly e.g., allocating higher daily budget on weekdays with better expected performance and lower daily budget on weekdays with lower expected performance may enhance the overall performance or Return on Investment (ROI) of the ad sets.

Also, there are scenarios for advertisers, where only a fraction of the daily budget is spent every day (i.e., daily budget utilization is low). Therefore, allocating the same budget every day may lead to under-utilization of the total advertising budget. The daily budget may be scaled-up or scaled-down in accordance with the daily budget utilization.

Utilizing the user set up information related to the total advertising budget and the time duration, on any given day, the embodiments presented herein may provide a budget pacing solution that paces the total advertising budget for the ad sets considering both—(i) Expected performance of ad sets for the day, and (ii) Leftover budget (i.e., remaining budget & remaining days) to come up with the optimal daily budget.

Thus, the determination of the total budget may ensure that an optimal (optimal in terms of targeted revenue generation from the ad sets) portion of the total budget is spent on each day for ad sets across different advertisement platforms. Also, it may be ensured that advertisers do not end up allocating the same budget every day for the ad sets across different advertisement platforms.

Further, in step 208, the budget distributor module 108 may select a budget distributor model from a plurality of budget distributor models (that may be stored in the digital advertisement optimization system 104). The selection of the budget distributor model may facilitate optimal (optimal in terms of targeted revenue generation from the ad sets) distribution (or redistribution) of the total budget decided for the day in step 206 across different advertisement platforms. Further, the process of selecting the budget distributor model may be based at least in part on information provided by the advertiser or any other entity (this information may be provided along with the user set up information in step 202 or before step 202). Alternatively or additionally, the process of selecting the budget distributor model may be based at least in part on steps 702 and 704 described in FIG. 7. Further, the budget distributor module 108 may be operable to integrate one or more user-defined budget distributor models later to the plurality of budget distributor models (stored in a memory of the digital advertisement optimization system 104) via the plug-and-play mechanism. In some embodiments, the plurality of budget distributor models includes at least a linear programming based distributor model. Further, the plurality of budget redistributor models may include non-linear optimization models such as, but not limited to, gradient descent model and bandit based model.

In step 210, the budget distributor module 108 may distribute the total daily budget across the plurality of advertisement platforms based at least in part on the selected budget distributor model. In some embodiments, the budget distributor module 108 may distribute the total daily budget by comparing performances of one or more of the plurality of advertisement platforms using a wRPS of each advertisement platform, and distributing the total daily budget across the plurality of advertisement platforms by providing results of the comparison to the selected budget distributor model.

Once the optimal total budget for a given day is fixed (e.g., in step 206), the next task for the digital advertisement optimization system 104 is to optimally distribute this fixed budget across different advertisement platforms. Step 210 results in optimal distribution of the total daily budget for ad sets across different advertisement platforms. In some embodiments, the budget distributor module 108 may consider the performance of the ad sets across different advertisement platforms when determining the budget for each advertisement platform.

Using conventional methodologies, advertisers may find it difficult to compare performance of their ad sets across different advertisement platforms on a more frequent basis since data for each advertisement platform is available only within the advertisement platform. In some embodiments, the budget distributor module 108 may aggregate data (related to performances of different advertisement platforms) from different advertisement platforms on a regular basis (in an example, on a daily basis), and optimally redistribute the budget across different advertisement platforms on a regular basis (in an example, redistribution of the budget is done once every day) based at least in part on the performances of different advertisement platforms. In some embodiments, the budget distributor module 108 may standardize performance of the ad sets across the plurality of advertisement platforms based at least in part on the selected budget distributor model when distributing the total daily budget across the plurality of advertisement platforms.

Further, in step 212, the single platform budget distributor module 110 may select (for each advertisement platform), one or more single platform budget optimization models from a plurality of single platform budget optimization models. The selection of the one or more single platform budget optimization models may facilitate optimal (optimal in terms of targeted revenue generation from the ad sets) distribution of the budget determined for each advertisement platform for the day in step 210 across different ad sets within each advertisement platform. Further, the process of selecting the one or more single platform budget optimization models may be based at least in part on information provided by the advertiser or any other entity (this information may be provided along with the user set up information in step 202 or before step 202). Alternatively or additionally, the process of selecting the one or more single platform budget optimization models may be based at least in part on steps 702 and 704 described in FIG. 7.

Further, in step 214, the single platform budget distributor module 110 may allocate budget from the distributed total daily budget and within each advertisement platform for the digital advertisement optimization, to ad sets based at least in part on the selected budget pacing model, the selected budget distributor model, and the selected one or more single platform budget optimization models. This allocation may be optimal in terms of targeted revenue generation from the ad sets. Further, in some embodiments, the process of budget allocation among different ad sets within each advertisement platform may be based at least in part on obtaining data (related to performances of ad sets within each advertisement platform) from different advertisement platforms on a timely basis, and optimally allocating the budget across different ad sets with each advertisement platform on a timely basis based at least in part on the performances of ad sets within each advertisement platform.

Some embodiments presented herein result in allocation of advertising platform budget (for each advertisement platform) within its children ad sets based on the performance (of ad sets) over a time duration.

Further, in step 216, the single platform budget distributor module 110 may perform bid optimization tasks and budget optimization tasks on the ad sets for each advertisement platform, based at least in part on the selected one or more single platform budget optimization models. In some embodiments, these bid optimization tasks and budget optimization tasks may include tasks related to optimal allocation of budgets and optimal bid recommendations for ad sets across each advertisement platform. In some additional embodiments, the bid optimization tasks and budget optimization tasks may be performed based at least in part on obtaining data related to performances of ad sets (on which budget is to be allocated and bid is to be placed) within each advertisement platform, from different advertisement platforms on a timely basis. Further, in such additional embodiments, the bid optimization tasks and budget optimization tasks may be performed further based at least in part on optimally allocating the budget and placing the bids across different ad sets with each advertisement platform on a timely basis, based at least in part on the performances of ad sets within each advertisement platform. In some embodiments, the single platform budget distributor module 110 may determine one or more bid recommendations for the ad sets of each advertisement platform. In some embodiments, the single platform budget distributor module 110 may perform the bid optimization tasks and the budget optimization tasks by determining performance scores for the ad sets across the plurality of advertisement platforms, recommending a bid and a budget for each of the ad sets based at least in part on the determined performance scores, and performing the bid optimization tasks and the budget optimization tasks across the plurality of advertisement platforms based at least in part on the recommendations. In some embodiments, the performance scores may include three types of scores. The first type of performance scores may be performance scale scores that is related to the scale aspect and provides the number of results obtained for ad sets. The second type of performance scores may be performance cost score that indicates a measured cost aspect (i.e., total money spent to obtained one result, basically cost of each result for the ad set). The third type of performance scores is engagement score that indicates a measured engagement aspect (i.e., the number of posts, comments, likes, etc. obtained by one or more ads of ad sets).

Performing the bid optimization tasks and budget optimization tasks may lead to increased revenue generation for the products or services related to the monitored ad sets, according to the embodiments presented herein.

Further, in step 218, the smart actions module 112 may automate strategies for the ad sets across different advertisement platforms to optimize the bid optimization tasks and the budget optimization tasks performed by single platform budget distributor module 110 in step 216. Furthermore, in step 220, the smart actions module 112 may provide one or more additional strategies (in addition to automating the strategies) for the ad sets to improve performance of the ad sets across different advertisement platforms.

Through steps 218 and 220, the smart actions module 112 may set up different triggers (associated with actions to be taken on ad sets) based on conditions met by different performance metrics of the ad sets. Further, the smart actions module 112, through steps 218 and 220, may also set up actions to be taken (on the ad sets) when the conditions are met.

In an example, the smart actions module 112 may automate a strategy that may recommend an increase in budget for one or more ad sets that have good CPR (CPR greater than a threshold value) and that gives higher number of results (scale) as compared to other ad sets with similar budget (but with low CPR (CPR less than or equal to a threshold value)). Further, the automated strategy may recommend a decrease in budget for one or more ad sets that does not deliver desired returns.

Further, the one or more additional strategies for the ad sets may include strategies designed to improve the performance of the ad sets (in terms of revenue generation) and that are based on performance metrics associated with the one or more ad sets.

The one or more additional strategies may be provided (by the smart actions module 112) in case of stagnation in the performance of the ad sets. These strategies may be custom made (user specified) and may be used as templates which can be applied on different ad sets in case of performance-based issues with the ad sets. The templates may recommend different actions (to be taken on the ad sets) based on different performance criteria related to the ad sets. Further, the smart actions module 112 may provide advertisers the flexibility to set the recommended actions for each performance criteria associated with the ad sets.

Through the exemplary process described by FIG. 2, advertisers may be able to optimally pace their advertising budget across a period of time and across different advertisement platforms (cross advertisement platforms).

FIG. 3 illustrates the various components of a budget pacing module 302 (implementing an adaptive sarimax pacer model in an example), according to some embodiments. The budget pacing module 302 of FIG. 3 may include two sub-modules. A sub-module of the budget pacing module 302 may be a results per spend (RPS) forecaster 304 and the other sub-module of the budget pacing module 302 may be a budget pacer 306.

The RPS forecaster 304 may forecast the RPS for any given time period (in an example, in a day) for the ad sets using the historical data available with the digital advertisement optimization system 104 or derivable by the digital advertisement optimization system 104 from one or more other entities (not shown in the figures). The RPS forecaster 304 may provide the advertisers with the ROI that can be expected for every unit of money spent on a particular day. The RPS forecaster 304 may use AI and machine learning (ML) techniques such as, but not limited to, regression, time series forecasting, and other advanced techniques (known in the art) to learn patterns and seasonality in RPS in the historical data of RPS and make predictions for a future period (in an example, day(s)).

The budget pacer 306 may take in the RPS forecast for a given day and compare the forecast with an average historical RPS actually observed. If the forecasted RPS is higher than the historical average RPS, then the budget pacer 306 may tend to set a higher budget than the baseline budget (baseline budget=remaining budget/remaining days).

Thus, in some embodiments, the budget pacing module 302 may determine a total daily budget (to be spent on ad sets across all advertising platforms) for a time duration.

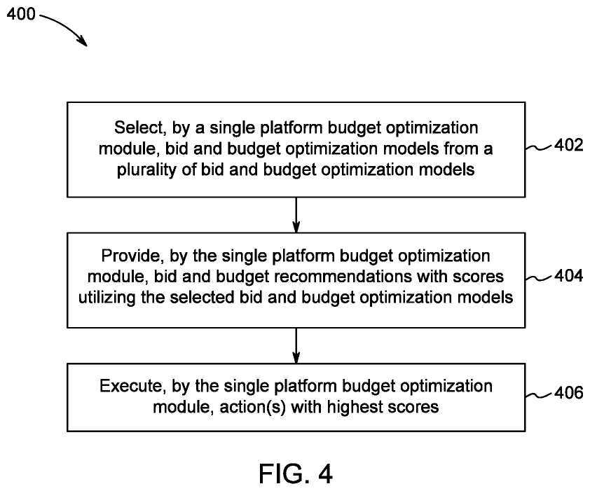

FIG. 4 illustrates an exemplary process 400 performed by the single platform budget optimization module 110 for providing bid and budget recommendations, according to some embodiments. In some embodiments, the plurality of single platform budget optimization models may include bid and budget optimization models which in turn may include state-based models, heuristic models, and bandit-based models. Further, state-based models, heuristic models, and Bandit-based models are models well known in the art and have not been described in detail in this disclosure for the sake of brevity of the disclosure.

In step 402 of FIG. 4, the single platform budget optimization module 110 may select a bid optimization model and a budget optimization model from a plurality of bid and budget optimization models. Further, the process of selecting the bid and budget optimization models may be based at least in part on information provided by the advertiser or any other entity. Alternatively or additionally, the process of selecting the bid and budget optimization models may be based at least in part on the steps described in FIG. 7. The single platform budget optimization module 110 may perform the bid and budget optimization tasks based at least in part on the selected bid and budget optimization models.

Further, in step 404 of FIG. 4, the single platform budget optimization module 110 may provide bid and budget recommendations with performance scores (for ad sets across different advertising platforms) utilizing the selected bid and budget optimization models. The provided bid and budget recommendations with performance scores may be used to perform bid and budget optimization tasks.

Further, in step 406, the single platform budget optimization module 110 may execute action(s) (to be taken on ad sets) with highest performance scores. In some embodiments, the action(s) may include allocating more budget to the ad sets having highest performance scores. Thus, the single platform budget optimization module 110 may perform bid and budget optimization tasks on ad sets for each advertisement platform.

FIG. 5 illustrates an exemplary process performed by an action type recommender module 114 for suggesting action types for advertisement platforms, according to some embodiments. In some embodiments, it may happen that (for performance stagnation of ad sets across different advertisement platforms) bid and budget may not be the only factors that play an important role. Many times, there may be different causes for performance stagnation of ad sets such as, but not limited to, exhaustion of creativity in the ad sets and audience saturation. In such scenarios, the action type recommender module 114 may analyses the input funnel metrics (metrics associated with total audience reach and performance related metrics) of the ad sets to understand the underlying cause and then recommend suitable action(s) types (actions).

In some embodiments, the action type recommender module 114 may include two sub-modules. One sub-module may be a metrics analyzer 502 which may analyze the input funnel metrics (metrics associated with total audience reach and performance related metrics) of the ad sets to identify underlying cause(s). The other sub-module may be an action type recommender 504 that analyses the identified cause(s) and suggests or recommends one or more action types to be performed on the ad sets (to overcome their performance stagnation).

In some embodiments, the one or more action types may include one or more of changing advertisement creativity for the ad sets, and updating parameters related to the ad sets.

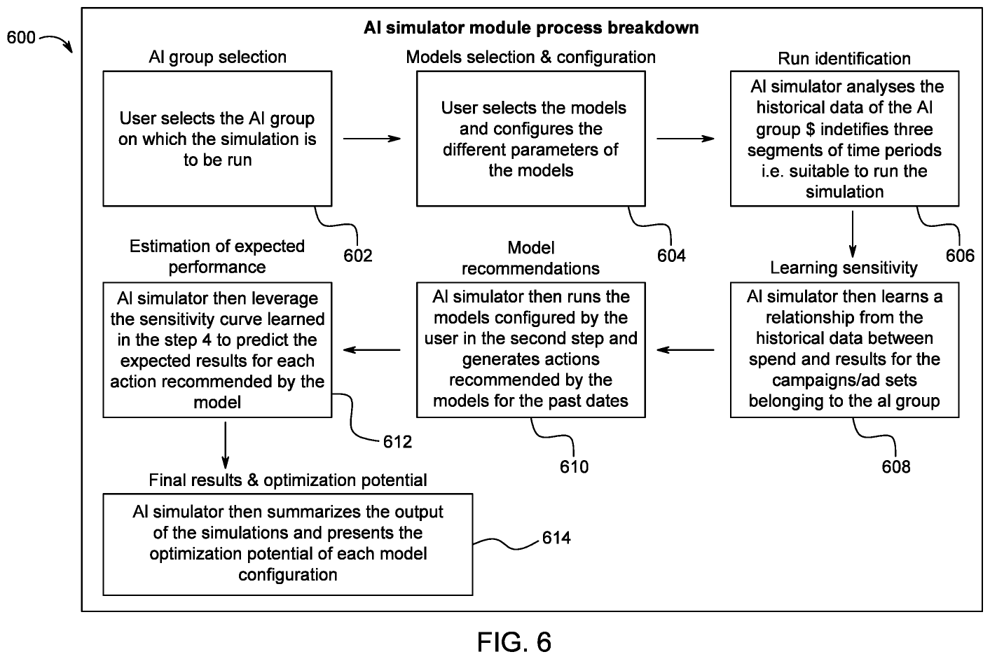

FIG. 6 illustrates an exemplary process performed by an AI simulator module 116 for presenting optimization potential of each model (budget pacing model(s), budget distributor model(s), and/or single platform budget optimization model(s)) configuration, according to some embodiments. The AI simulator module 116 is provided by the digital advertisement optimization system 104 with the intent of enabling the advertiser or any other entity to test different models (budget pacing model(s), budget distributor model(s), and/or single platform budget optimization model(s)) in the historical time period (and on ad sets (or its associated data) across different advertisement platforms) and select models (for digital advertisement optimization) from amongst the tested models based at least in part on results of the test.

Step 602 of FIG. 6 relates to AI group selection. In step 602, the AI simulator module 116 may enable a user (the advertiser or any other entity) to select an AI group on which a simulation is to be performed. In some embodiments, the AI group may include a group of ad sets on which the user wants to simulate any model (budget pacing model, budget distributor model, and/or single platform budget optimization model) in the historical time period.

Step 604 of FIG. 6 relates to model selection and configuration. In step 604, the AI simulator module 116 may enable the user to select the models (budget pacing models, budget distributor models, and/or single platform budget optimization models) and configure associated parameters (in some examples, the parameters include stance i.e., aggressive or conservative, and maximum % change in budget allowed by a model etc.).

Step 606 of FIG. 6 relates to run identification. In step 606, the AI simulator module 116 may analyze the historical data of the AI group and identify three segments of time periods that have low spend variance for the ad sets.

Step 608 of FIG. 6 relates to learning sensitivity. In step 608, the AI simulator module 116 may learn a relationship from the historical data between the spend and results for the ad sets belonging to the AI group.

Step 610 of FIG. 6 relates to model (budget pacing model, budget distributor model, and/or single platform budget optimization model) recommendations. In step 610, the AI simulator module 116 may run the models configured by the user in the step 604 and generate actions recommended by the models for the past period (dates).

Step 612 of FIG. 6 relates to estimation of expected performance. In step 612, the AI simulator module 116 may leverage the sensitivity curve (spend vs results curve) learned in step 608 to predict the expected results for each action recommended (in step 610) by the model.

Step 614 of FIG. 6 relates to final results and optimization potential. In step 614, the AI simulator module 116 may summarize the output of the simulations (on the AI group), present the optimization potential of each model configuration (model configuration for budget pacing models, budget distributor models, and/or single platform budget optimization models), and enable user to select one or more of a budget pacing model, a budget distributor model, and/or one or more single platform budget optimization models, based at least in part on the presented optimization potential.

Thus, the AI simulator module 116 allows the user to achieve expected ROI's with respect to their ad sets. Further, the AI simulator module 116 allows the user to easily understand the expected lift in performance generated by the models through the presented optimization potential.

The AI simulator module 116 may enable the user to test (in historical time period and on historical data related to the ad sets of user) budget optimization model(s), budget distributor model(s), and single platform budget optimization model(s), and simulate different scenarios through adjusting parameters of the models. The AI simulator module 116 learns from the historical data, the behavior of ad sets of the user with respect to changing budgets for the ad sets of the user. It then uses this learning to measure the effect of running the models on their ad sets. Finally, the AI simulator module 116 summaries the overall expected performance of the model with respect to their ad sets. The AI simulator module 116 not only helps the user to understand the expected behavior and performance of the tested models but also allows them to tweak a few parameters of the models to customize them to their ad sets so as to have best performance (in terms of targeted ROIs).

Thus, the AI simulator module 116 may provide a “data-driven” digital advertisement optimization approach.

FIG. 7 illustrates an exemplary flowchart depicting the various steps performed by an AI simulator module 116 for facilitating selection of one or more models (that may be used to fix budget for ad sets across different advertisement platforms), according to some embodiments.

In some embodiments, in step 702, the AI simulator module 116 may test one or more of a plurality of budget pacing models, a plurality of budget distributor models, and a plurality of single platform budget optimization models, on a historical set of data related to ad sets of advertisement platforms. In some embodiments, the AI simulator module 116 may obtain the historical set of data related to ad sets from the advertisers or any other entity.

Next, in step 704, the AI simulator module 116 may facilitate selection of one or more of a budget pacing model, a budget distributor model, and one or more single platform budget optimization models (by one or more of the budget pacing module 106, the budget distributor module 108, and the single platform budget optimization module 110) based at least in part on results of the testing. In some embodiments, the AI simulator module 116 may provide the results of the testing to one or more of the budget pacing module 106, the budget distributor module 108, and the single platform budget optimization module 110, and thus facilitate in the selection process of the various models described above.

Further, one or more aspects related to the AI simulator module 116 are described in more detail in the context of FIG. 6 described earlier and therefore, have not been described in detail in here for the sake of brevity.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD-ROMs, DVDs, flash drives, disks, and any other known physical storage media.

The terms “comprising.” “including.” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

1. A method implemented by a system for digital advertisement optimization, the method comprising:
selecting a budget pacing model from a plurality of budget pacing models;
selecting a budget distributor model from a plurality of budget distributor models; and
allocating a budget, within each advertisement platform of a plurality of advertisement platforms for the digital advertisement optimization, to advertisement sets based at least in part on the selected budget pacing model, the selected budget distributor model, and one or more single platform budget optimization models.

2. The method of claim 1, further comprising:
determining a total daily budget for a time duration based at least in part on the selected budget pacing model; and
distributing the total daily budget across the plurality of advertisement platforms based at least in part on the selected budget distributor model, wherein the budget is allocated from the distributed total daily budget.

3. The method of claim 2, further comprising obtaining user set up information through a user interface.

4. The method of claim 2, wherein determining the total daily budget comprises forecasting a number of results per day for a unit cost spent on one or more advertisements across the plurality of advertisement platforms, wherein the number of results per day comprises a number of clicks and a number of conversions associated with the one or more advertisements.

5. The method of claim 4, wherein determining the total daily budget further comprises:
comparing the forecasted number of results per day with historical data associated with the one or more advertisements based at least in part on the selected budget pacing model; and
determining the total daily budget based at least in part on results of the comparison,
wherein the total daily budget is variable based at least in part on the results of the comparison.

6. The method of claim 2, wherein distributing the total daily budget comprises:
comparing performances of one or more of the plurality of advertisement platforms using a weighted average of results per spend of each advertisement platform; and
distributing the total daily budget across the plurality of advertisement platforms by providing results of the comparison to the selected budget distributor model.

7. The method of claim 1, further comprising:
integrating one or more user-defined budget pacing models to the plurality of budget pacing models via a plug-and-play mechanism; and
integrating one or more user-defined budget distributor models to the plurality of budget distributor models via the plug-and-play mechanism.

8. The method of claim 1, wherein the plurality of budget pacing models comprises at least an adaptive sarimax pacer model, and wherein the plurality of budget distributor models comprises at least a linear programming based distributor model.

9. The method of claim 1, further comprising determining one or more bid recommendations and one or more action types for the advertisement sets of each advertisement platform.

10. The method of claim 1, further comprising standardizing performance of the advertisement sets across the plurality of advertisement platforms based at least in part on the selected budget distributor model.

11. The method of claim 1, further comprising:
selecting, for each advertisement platform, the one or more single platform budget optimization models from a plurality of single platform budget optimization models;
performing bid optimization tasks and budget optimization tasks on the advertisement sets for each advertisement platform, based at least in part on the selected one or more single platform budget optimization models;
automating strategies for the advertisement sets across the plurality of advertisement platforms, to optimize the bid optimization tasks and the budget optimization tasks; and
providing one or more additional preconfigured strategies for the advertisement sets, to improve performance of the advertisement sets across different advertisement platforms.

12. The method of claim 11, wherein selecting one or more of the budget pacing model, the budget distributor model, and the one or more single platform budget optimization models comprises:
testing one or more of the plurality of budget pacing models, the plurality of budget distributor models, and the plurality of single platform budget optimization models, on a historical set of data related to other advertisement sets; and
facilitating selection of one or more of the budget pacing model, the budget distributor model, and the one or more single platform budget optimization models, based at least in part on the testing.

13. The method of claim 11, wherein performing the bid optimization tasks and the budget optimization tasks comprises:
determining performance scores for the advertisement sets across the plurality of advertisement platforms;
recommending a bid and a budget for each of the advertisement sets based at least in part on the determined performance scores; and
performing the bid optimization tasks and the budget optimization tasks across the plurality of advertisement platforms based at least in part on the recommendations.

14. The method of claim 11, further comprising performing multiple actions per day on the advertisement sets based at least in part on monitoring the performance of the advertisement sets across the different advertisement platforms.

15. The method of claim 14, wherein performing the multiple actions per day comprises recommending one or more types of actions to be taken on the advertisement sets in response to detecting performance stagnation in the advertisement sets, and wherein the types of actions comprise one or more of changing advertisement creativity for the advertisement sets, and updating parameters related to the advertisement sets.

16. A digital advertisement optimization system for digital advertisement optimization, the system comprising:
a budget pacing module operable to select a budget pacing model from a plurality of budget pacing models;
a budget distributor module operable to select a budget distributor model from a plurality of budget distributor models; and
a single platform budget optimization module operable to allocate a budget, within each advertisement platform of a plurality of advertisement platforms for the digital advertisement optimization, to advertisement sets based at least in part on the selected budget pacing model, the selected budget distributor model, and one or more single platform budget optimization models.

17. The system of claim 16, wherein:
the budget pacing module is further operable to determine a total daily budget for a time duration based at least in part on the selected budget pacing model; and
the budget distributor module is further operable to distribute the total daily budget across the plurality of advertisement platforms based at least in part on the selected budget distributor model, wherein the budget is allocated from the distributed total daily budget.

18. The system of claim 16, wherein:
the budget pacing module is further operable to integrate one or more user-defined budget pacing models to the plurality of budget pacing models via a plug-and-play mechanism; and
the budget distributor module is further operable to integrate one or more user-defined budget distributor models to the plurality of budget distributor models via the plug-and-play mechanism.

19. The system of claim 16, wherein the single platform budget optimization module is further operable to:
select, for each advertisement platform, the one or more single platform budget optimization models from a plurality of single platform budget optimization models; and
perform bid optimization tasks and budget optimization tasks on the advertisement sets for each advertisement platform, based at least in part on the selected one or more single platform budget optimization models.

20. The system of claim 19, further comprising an artificial intelligence (AI) simulator module, wherein the AI simulator module is operable to:
test one or more of the plurality of budget pacing models, the plurality of budget distributor models, and the plurality of single platform budget optimization models, on a historical set of data related to other advertisement sets; and
facilitate the selection of one or more of the budget pacing model, the budget distributor model, and the one or more single platform budget optimization models, based at least in part on results of the test.
